(19) United States
(12) Patent Application Publication
(10) Pub. No.: US 2010/0306912 A1
(43) Pub. Date: Dec. 9, 2010

(54) PERINEAL SELF-CLEANSING SYSTEM AND METHOD OF USE

(76) Inventor: George Allen McCabe, Dix, IL (US)

Correspondence Address: Polster, Lieder, Woodruff & Lucchesi, L.C., 12412 Powerscourt Dr. Suite 200, St. Louis, MO, 63131-3615, US

(21) Appl. No.: 12/796,138

(22) Filed: Jun. 8, 2010

Related U.S. Application Data
(60) Provisional application No. 61/217,952, filed on Jun. 8, 2009.
(60) Provisional application No. 61/217,990, filed on Jun. 8, 2009.

(51) Int. Cl. A61H 35/00

(52) U.S. Cl. 4/443

(57) ABSTRACT

A perineal self-cleansing system (10) includes a cleanser (12) detachably connected to a fluid source (14) with a hose (70) and a stool (16) for positioning and supporting a patient and exposing the perineal region during the cleansing process. The cleanser (12) includes a flow control (62) detachably connected between the hose (70) and a conduit (40). The conduit (40) includes a linear portion (42) and an angled portion (44) terminating in a nozzle (46) for directing a stream of fluid flow at the perineal region for cleansing.

### CROSS-REFERENCE TO RELATED APPLICATIONS

This application is related to U.S. Provisional Patent Application No. 61/217,952 filed Jun. 8, 2009 and U.S. Provisional Patent Application No. 61/217,990 filed Jun. 8, 2009 from which priority is claimed, and both of which are hereby incorporated by reference.

### STATEMENT REGARDING FEDERALLY SPONSORED RESEARCH

Not Applicable.

### BACKGROUND

The present disclosure relates to a system for self-cleansing a perineal region. The perineum or perineal region is generally defined as the surface region in both males and females between the pubic symphysis and the coccyx. After various medial procedures, such as fistula surgery, or childbirth, it can be necessary to regularly cleanse the perineal region for hygienic and comfort purposes. In some situations, medical staff can perform cleansing of the perineal region for patients, in particular, for patients who are unable to perform the cleansing independently, for example, because of a physical or mental disability. However, for capable patients typically prefer self-cleansing without the aid of medical staff. Self-cleansing allows a patient to maintain privacy and perform the cleansing according to the patients own schedule. In addition, the elimination of medical staff from the procedure allows a patient to self-cleanse at home or other desired location.

### DESCRIPTION OF THE DRAWINGS

In the accompanying drawings which form part of the specification:

FIG. 1 is a perspective view of a perineal cleaning system, in accordance with the present disclosure;

FIG. 2 is an exploded perspective view of a cleanser;

FIG. 3 is a side view of a seat;

FIG. 4 is an end view of a first embodiment of a nozzle;

FIG. 5 is an end view of a second embodiment of a nozzle;

FIG. 6 is an end view of a third embodiment of a nozzle;

FIG. 7 is an end view of a fourth embodiment of a nozzle;

FIG. 8 is an end view of a fifth embodiment of a nozzle;

FIG. 9 is an end view of a sixth embodiment of a nozzle; and

FIG. 10 is an end view of a seventh embodiment of a nozzle.

Corresponding reference numerals indicate corresponding parts throughout the several figures of the drawings.

### DETAILED DESCRIPTION

The following detailed description illustrates the claimed invention by way of example and not by way of limitation. The description clearly enables one skilled in the art to make and use the claimed invention, describes several embodiments, adaptations, variations, alternatives, and uses of the claimed invention, including what is presently believed to be the best mode of carrying out the claimed invention. Additionally, it is to be understood that the claimed invention is not limited in its application to the details of construction and the arrangements of components set forth in the following description or illustrated in the drawings. The claimed invention is capable of other embodiments and of being practiced or being carried out in various ways. Also, it is to be understood that the phraseology and terminology used herein is for the purpose of description and should not be regarded as limiting.

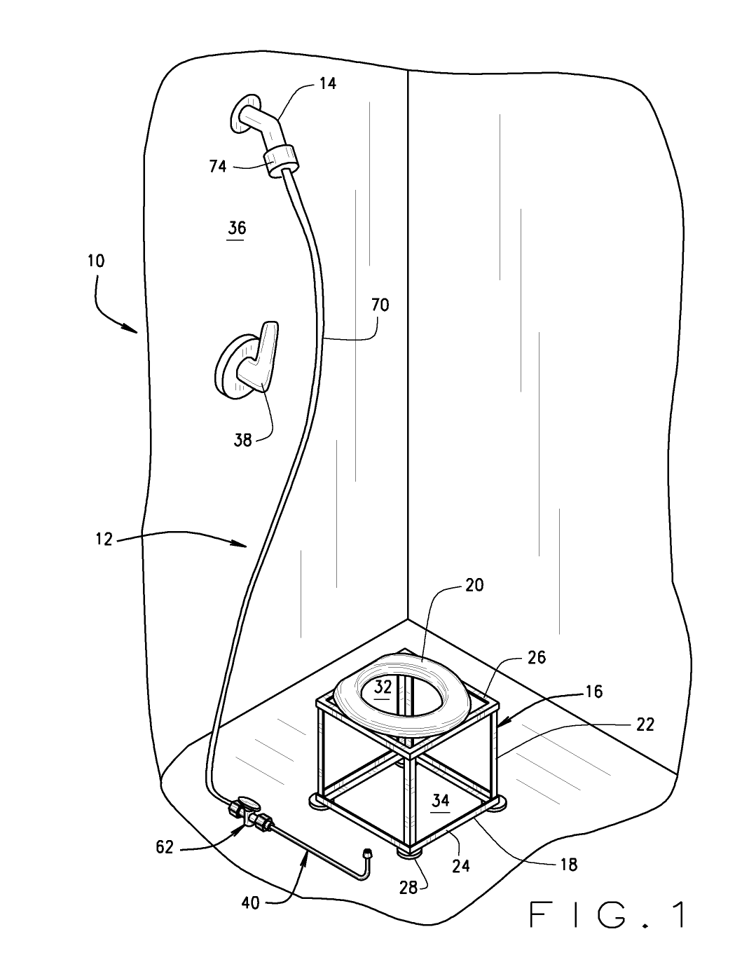

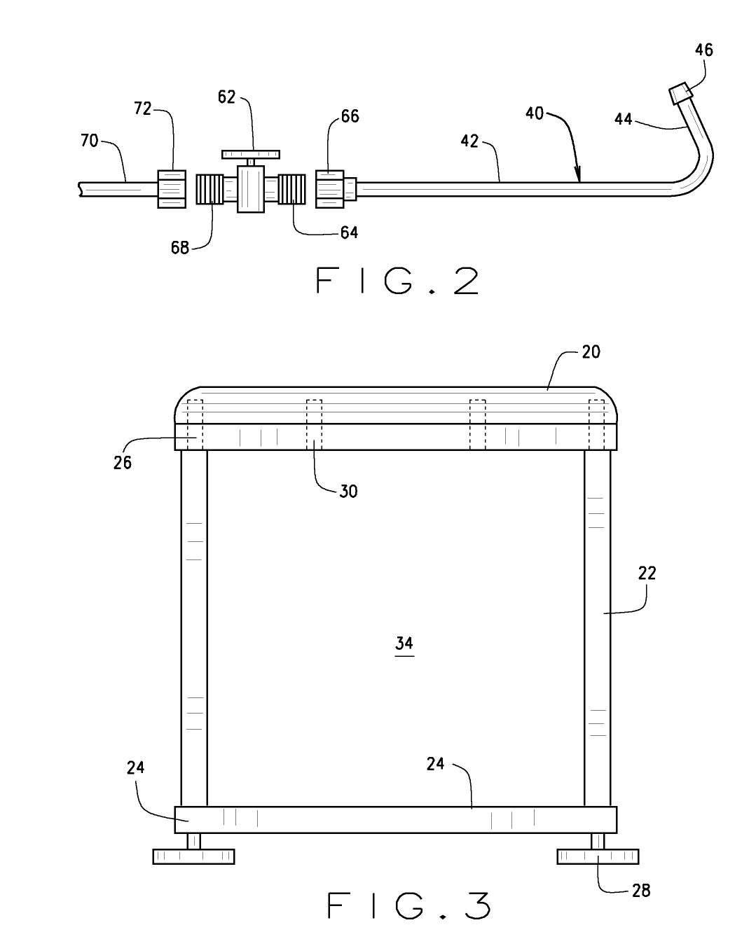

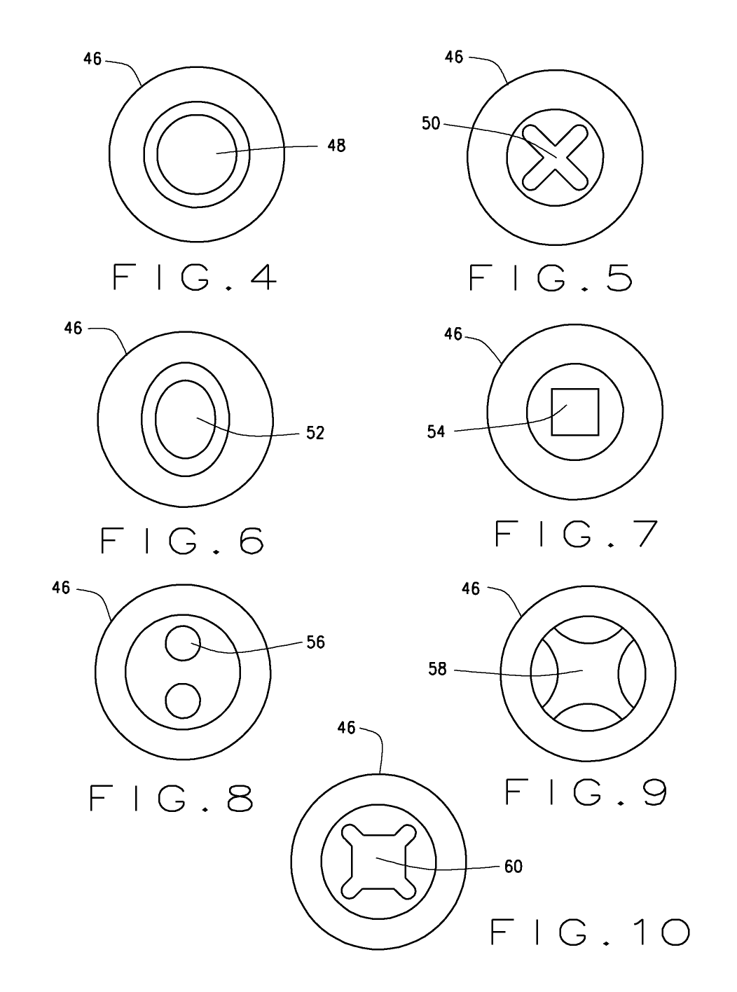

As shown in FIGS. 1-10, an embodiment constructed in accordance with the present disclosure, generally referred to as a perineal self-cleansing system 10, includes a cleanser 12 detachably connected to a fluid source 14 and a stool 16 for positioning and supporting a patient and exposing the perineal region during the cleansing process.

The stool 16 includes a base 18 and a seat 20 attached to the top of the base 18 to position and support the patient and expose the perineal region during the self-cleansing process. (FIGS. 1 and 3). The stool 16 is generally cube-shaped with four generally vertical legs 22 extending between respective corners of a generally square lower member 24 and a generally square upper member 26. Non-slip feet 28 are attached at respective bottom corners of the base 18. The feet are preferably vertically adjustable to accommodate the base 18 resting on unlevel surfaces.

The seat 20 attaches to the upper member 26, such as with fasteners 30, but any suitable means for attachment can be used, including, but not limited to adhesive or welding. The seat 20 is generally oval and defines an opening 32 sized an shaped to expose the perineal region of the patient when seated on the seat 20. However, the seat 20 and opening 32 can be any size and shape that adequately positions and support the patient and expose the patient's perineal region for self-cleansing, including, but not limited to rectilinear and curvilinear shapes. The base 18 defines a open area 34, such as a cavity or a channel, generally below the opening 32 of the seat 20 to receive and position the cleanser 12 for self-cleansing of the perineal region.

Although the embodiment of FIGS. 1-3 illustrate a generally cube-shaped base 18 and generally oval seat 20, the base 18 and seat 20 can comprise any shape and size that positions and supports the patient, exposes the perineal region, and provides an open space for receiving and positioning the cleanser 12. For example, the base 18 can be generally triangular shaped having three vertical legs 22. Alternatively, the base 18 can be a generally circular and unitary member defining an opening to the open space 34 for insertion of the cleanser 12. In addition, the seat 20 is preferably positioned at a low-profile height to reduce stress on a patients legs and knees when seated on seat 20 during the cleansing process, which can take several minutes or more to perform.

To withstand repeated exposure to water and other fluids, the stool 16 is preferably made from waterproof materials, including, but not limited to, plastic, stainless steel, aluminum, or treated wood. In addition, the seat 20 can also be made from a generally soft material, including, but not limited to, foam or rubber, to provide a comfortable surface for the patient while seated on the stool 16.

If desired, the stool 16 can incorporate other features including, but not limited to, telescoping or adjustable legs 22 to provide height adjustment of the seat 20, a collapsible base to provide for easier storage and transport of the stool 16, handles extending upwardly from the base to provide additional support and stability to the patient, supplemental supports on the base and seat to accommodate overweight or otherwise large patients.

As shown in FIG. 1, the fluid supply 14 is preferably a shower arm extending from a wall 36 of a shower. A valve (not shown) located behind the shower wall 36 is operatively connected to the shower arm 14. A handle 38 is moveably connected to the valve to control the flow of hot and cold water through the valve to the shower arm 14. Although the fluid supply is shown as a shower arm 14, those skilled in the art will recognize that the fluid supply can be any suitable fluid source, including, but not limited to, a faucet or a fluid container.

The cleanser 12 includes a conduit 40 having a generally linear portion 42 and an generally angled portion 44 that terminates in or about a nozzle 46, which is removeable and replaceable. (FIG. 2). The angled portion 44 is preferably at an acute angle relative to the linear portion 42 of between about 45° and about 89° so that the patient can properly position the nozzle 46 for cleansing of the perineal region. However, any angle can be used that allows the patient to properly position the nozzle 46 for cleansing of the perineal region. For instance, the angle relative to the linear portion 42 can be at a right angle or at an obtuse angle of about 91° to about 135°. Furthermore, the angle of the nozzle 46 can be adjustable. The length of the linear portion 42 is preferably sufficient to extend from approximately adjacent the base 18 into the open space 34 so that the angled portion 44 is positioned below the opening 32 of the seat 20. However, the length of the linear portion 42 can be longer or shorter to properly position the nozzle 46 for cleansing of the perineal region.

In the embodiment of FIGS. 1-4, the nozzle 46 defines a generally circular opening 48 to determine the direction and characteristics of a stream of fluid at a desired flow rate and in a desired flow pattern. However, the nozzle 46 can define other shapes and sizes to determine the direction and characteristics of the stream of fluid at another desired flow rate and in a desired flow pattern as shown in FIGS. 5-10. FIG. 5 shows a nozzle 46 with a having a generally X-shaped opening 50. FIG. 6 illustrates a nozzle 46 having an obround opening 52. FIG. 7 depicts a nozzle 46 with a square opening 54. FIG. 8 shows a nozzle 46 with a pair of circular openings 56. FIG. 9 illustrates a nozzle 46 with a generally square opening 58 having arcuate sides. FIG. 10 depicts a nozzle 46 with a generally square opening 60 having protrusions extending outwardly from each corner. In addition, the nozzle 46 can include internal elements sized and shaped to determine the direction and characteristics of the fluid flow, such as, a diffuser, an aerator, an atomizer, a swirl element, and the like. Each opening 50 has desirable cleaning characteristics depending on how the nozzle directs the opening.

The conduit 40 is preferably made from a medical grade plastic, such as, high-density polyethylene (HDPE) or acrylonitrile butadiene styrene (ABS). However, those skilled in the art will recognize that any suitable material can be used, such as, metal. The material is preferably inexpensive so that the cleanser can be disposed of after a limited number of uses.

The cleanser 12 also includes a flow control valve 62 to control the flow and pressure of the fluid through the cleanser 12. The flow control valve 62 has a threaded outlet 64 for detachable connection to the linear portion 42 of the conduit 40, such as with a fitting 66, and a threaded inlet 68 for detachable connection with a generally flexible hose 70 such as with a fitting 72. The flow control valve 62 is preferably a quarter turn ball valve, however, any type of flow control valve can be used, including, but not limited to, a needle valve, a butterfly valve, a globe valve, or a gate valve. In addition, the inlet 68 and outlet 64 can substitute other types of connections in place of threads, including but not limited to, quick-connect couplings, or compression fittings. The flexible hose 70 includes an adapter 74 at the end opposite the flow control valve 62 that is shaped and sized to engage with the shower arm 14 or other fluid source. The flexible hose 70 is preferably made from a medical grade plastic, such as silicone, but any suitable material can be used including, but not limited to, polyurethane, or polyvinyl chloride (PVC).

In an alternate embodiment, the flow control valve 62 can be eliminated so that the conduit 42 connects directly to the flexible hose 70, such as with a fitting. In such an embodiments, the flow of the fluid is controlled at an alternate location, such as the valve and handle 38 of the shower, or a trigger on the hose 70 or conduit 40.

In operation, the patient positions the stool 16 within a desired location, such as a shower. The patient attaches the flexible hose 70 by securing the adaptor 74 to the shower arm 14. The patient seats himself on the seat 20 of the stool 16 so that the perineal region is exposed through the opening 32. After turning on the fluid source via the handle 38, the patient inserts the conduit 40 into the base 18 and positions the nozzle 46 so that the nozzle 46 is aimed at the perineal region. The patient engages the flow control 62 to begin directing fluid flow out of the nozzle 46 to cleanse the perineal region. When cleansing is completed, the patient terminates the flow using the flow control. It will be appreciated that the cleanser 12 may be used without the stool 16. For example, the patient may stand in the shower and clean the perineal region without sitting on the stool 16.

Changes can be made in the above constructions without departing from the scope of the invention, it is intended that all matter contained in the above description or shown in the accompanying drawings shall be interpreted as illustrative and not in a limiting sense.

What is claimed is:

1. A cleanser for self-cleansing of a patient's perineal region, comprising:
a fluid source;
a hose detachably connected to the fluid source;
a conduit detachably connected to the hose, the conduit having a generally linear portion and a generally angled portion; and
a nozzle detachably connected to the angled portion of the conduit, the nozzle being sized and shaped to direct a fluid from the fluid source at a selected flow rate and a selected flow pattern to the perineal region for cleansing.

2. The cleanser of claim 1, further comprising a flow control valve connected between the flexible hose and the conduit for adjustable control of the flow and pressure of the fluid.

3. The cleanser of claim 1 wherein the angled portion is at an angle relative to the linear portion between about 45° to about 89°.

4. The cleanser of claim 1 wherein the angled portion is at an angle relative to the linear portion between about 91° to about 135°.

5. The cleanser of claim 1 wherein the angled portion is at a right angle relative to the linear portion.

6. The cleanser of claim 1, further comprising a stool for seating a patient, the stool defining an opening sized and shaped for exposure of the perineal region.

7. The cleanser of claim 6, wherein the stool comprises:
a base;
a seat attached to the base, the seat shaped and sized to seat and support a patient; and
vertically adjustable feet attached to the base.

8. A perineal self-cleansing system, comprising:
a stool for seating a patient, the stool defining an opening sized and shaped for exposure of the perineal region of the patient seated on the stool;
a fluid source;
a hose detachably connected to the fluid source;
a conduit detachably connected to the hose, the conduit having a generally linear portion and a generally angled portion; and
a nozzle detachably connected to the angled portion of the conduit, the nozzle being sized and shaped to direct a fluid from the fluid source at a selected flow rate and a selected flow pattern to the perineal region for cleansing.

9. The system of claim 8, further comprising a flow control valve connected between the flexible hose and the conduit for adjustable control of the flow and pressure of the fluid.

10. The system of claim 8, wherein the angled portion is at an angle relative to the linear portion between about 45° to about 89°.

11. The system of claim 8, wherein the angled portion is at an angle relative to the linear portion between about 91° to about 135°.

12. The system of claim 8, wherein the angled portion is at a right angle relative to the linear portion.

13. The system of claim 8, wherein the stool comprises:
a base;
a seat attached to the base, the seat shaped and sized to seat and support a patient; and
vertically adjustable feet attached to the base.

14. A method for self-cleansing a perineal region of a patient, comprising the steps of:
providing a stool for seating a patient, the stool defining an opening sized and shaped for exposure of the perineal region;
seating the patient on the stool with the perineal region exposed through the opening;
providing a fluid source;
providing a hose detachably connected to the fluid source;
providing a conduit detachably connected to the hose, the conduit having a generally linear portion and a generally angled portion;
providing a nozzle detachably connected to the angled portion of the conduit, the conduit being sized and shaped to direct a fluid from the fluid source at a selected flow rate and a selected flow pattern to the perineal region for cleansing;
positioning the conduit with the nozzle aimed generally at the perineal region; and
communicating fluid from the fluid source through the hose, through the conduit, through the nozzle to the perineal region at the selected flow rate and the selected flow pattern to cleanse the perineal region.

15. The method of claim 14, further comprising:
providing a flow control valve connected between the flexible hose and the conduit; and
adjusting the flow and pressure of the fluid with the flow control valve.

16. The method of claim 14, wherein the angled portion is at an angle relative to the linear portion between about 45° to about 89°.

17. The method of claim 14, wherein the angled portion is at an angle relative to the linear portion between about 91° to about 135°.

18. The method of claim 14, wherein the angled portion is at a right angle relative to the linear portion.

19. The method of claim 14, wherein the stool comprises:
a base;
a seat attached to the base, the seat shaped and sized to seat and support a patient; and
vertically adjustable feet attached to the base.
